(19) United States
(12) Patent Application Publication
(10) Pub. No.: US 2008/0196062 A1
(43) Pub. Date: Aug. 14, 2008

(54) ELECTRONIC PROGRAM GUIDE HAVING PLURALITY OF PROGRAM CATEGORY GROUPS AND METHOD FOR FORMING ELECTRONIC PROGRAM GUIDE

(76) Inventor: Hsuan-Huei Shih, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/673,602

(22) Filed: Feb. 12, 2007

(51) Int. Cl. G06F 3/00

(52) U.S. Cl. 725/40

(57) ABSTRACT

The present invention provides an electronic program guide and a method for forming the electronic program guide thereof. The electronic program guide includes a plurality of program category groups each comprising at least one television channel. The method for forming the electronic program guide includes generating a plurality of program category groups, and categorizing a plurality of television channels into the program category groups according to program categories of the television channels. Therefore, the television channels are categorized based on their categories to benefit users to navigate through the television channels.

### BACKGROUND OF THE INVENTION

1. Field of the Invention

The invention relates to an electronic program guide and a method for forming the electronic program guide, and more particularly, to an electronic program guide having a plurality of program category groups and a method for forming the electronic program guide thereof.

2. Description of the Prior Art

An electronic program guide (EPG) is an application for listing current and scheduled television programs that are or will be available on each television channel, as well as brief information about each television program. In other words, an electronic program guide is the electronic equivalent of a typical printed television program guide. Users can easily set up a VCR to record television programs or update the new television program guide utilizing the electronic program guide.

However, since the assignation of channel numbers is not uniform in every region of the country, and the electronic program guide display will have the same channel names and the program names played in the associated channels as the traditional printed television program guide, when a user wants to search through movie channels (for example), or when the user is watching a specific movie channel and wants to switch to a sports channel (for example) the user needs to remember all the movie channel numbers and/or all the sports channel numbers. This becomes a difficult task when a total number of available channels is huge and the channels are not arranged in an order corresponding to their categories.

### SUMMARY OF THE INVENTION

Therefore, one of the objectives of the present invention is to provide an electronic program guide having a plurality of program category groups and a method for forming the electronic program guide thereof.

According to an exemplary embodiment of the present invention, an electronic program guide comprises a plurality of program category groups each comprising at least one television channel, and a method for forming the electronic program guide comprises generating a plurality of program category groups, and categorizing a plurality of television channels into the program category groups according to program categories of the television channels.

According to another exemplary embodiment of the present invention, an electronic program guide comprises a plurality of program category groups each comprising at least one television program, and a method for forming the electronic program guide comprises generating a plurality of program category groups, and categorizing a plurality of television programs into the program category groups according to program categories of the television programs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic program guide according to an exemplary embodiment of the present invention.

FIG. 2 is a diagram of a movie category in the electronic program guide in FIG. 1.

FIG. 3 is a flow chart illustrating the operation of forming the electronic program guide in FIG. 1.

### DETAILED DESCRIPTION

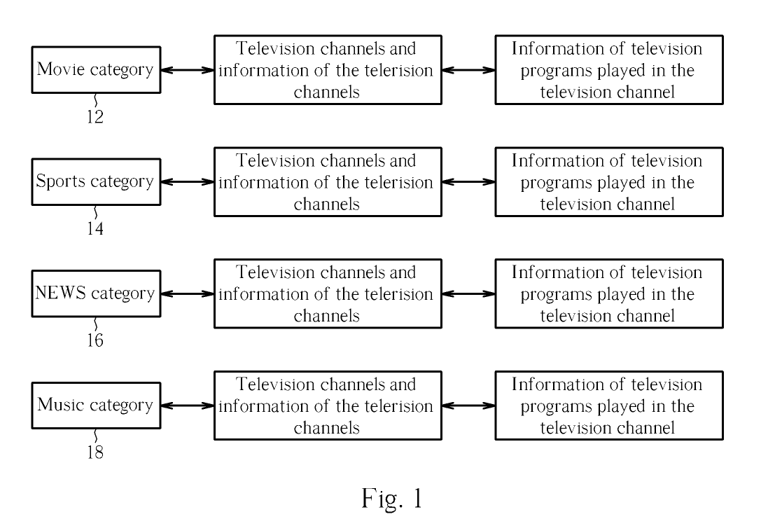

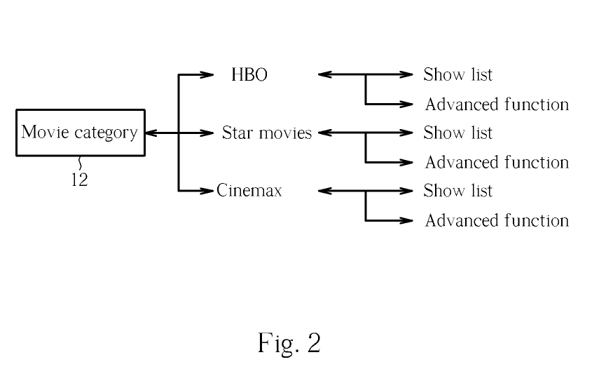

Please refer to FIG. 1, which illustrates a hierarchical architecture of an electronic program guide 10 according to an exemplary embodiment of the present invention. The electronic program guide 10 includes, but is not limited to, a plurality of program category groups, such as a movie category 12, a sports category 14, a NEWS category 16, a music category 18, or any combinations thereof, and each program category group comprises at least one television channel, information of the channel (e.g. a channel name or an associated channel number), and information concerning television programs (such as program names, playing order, and other advanced functions) of each associated television channel. Taking the movie category 12 as an example, as shown in FIG. 2, the television channels in the movie category 12 are HBO, Star Movies, Cinemax, etc., and within the HBO channel, a show list showing the program names, the playing order of the television programs played on the HBO channel, and some advanced functions, such as scheduled recording, are listed.

Please note that the configuration of the electronic program guide 10 in FIG. 1 is only an embodiment of the present invention. That is, in a second embodiment, the electronic program guide may have a mixed configuration of the plurality of program category groups and television channels, so they are not categorized according to program category groups as in the first embodiment. For example, they could be categorized according to ‘favorite channels’ or ‘English language channels’. These categorizations are merely examples and are not meant in any way to limit the present invention. In a third embodiment, the electronic program guide may not display the channel information, which means when the user selects the movie category, the information that he/she will get is the information of movie programs being played at that time (e.g. program names, playing order, and other advanced functions).

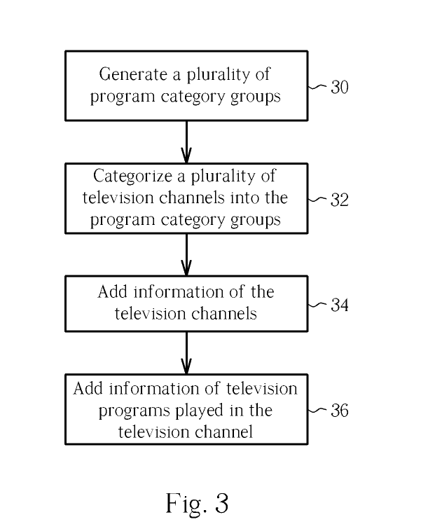

The present invention further provides a method for forming the electronic program guide. FIG. 3 is a flow chart illustrating the operation of forming the electronic program guide 10 in FIG. 1. As shown in FIG. 3, forming an electronic program guide includes the following steps:

Step 30: Generate a plurality of program category groups.

Step 32: Categorize a plurality of television channels into program category groups according to program categories of the television channels.

Step 34: Add information of the television channels such as channel names or associated channel numbers into each program category group.

Step 36: Add information of television programs played in the television channel such as program names, playing order, and other advanced functions into each program category group.

For the third embodiment of the electronic program guide, step 32 is modified to categorize a plurality of television programs into program category groups according to program categories of current television programs.

Therefore, the television channels and the programs are categorized based on a specific condition (e.g., their categories as mentioned in above embodiments). When a user is watching a program on the HBO channel and wants to switch to other movie channels, he/she does not need to remember all the channel numbers of the movie channels. By using the disclosed electronic program guide 10, the user can easily navigate through similar channels inside the movie category 12. Additionally, when the user is watching a program on the HBO channel and wants to switch to a sports channel, instead of inputting the sports channel numbers into the television one by one, he/she can select the sports category 14 first and then search the television channels recorded inside the sports category 14. Moreover, the program category groups can be predetermined or manually configured by the user himself/herself. Hence, the electronic program guide 10 of the present invention is flexible to fit different preference settings of different users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic program guide, comprising:
a plurality of program category groups each comprising at least one television channel.

2. The electronic program guide of claim 1, wherein each program category group further comprises information of television programs played on the television channel.

3. The electronic program guide of claim 1, wherein the program category groups comprise a movie category, a sports category, a NEWS category, a music category, or combinations thereof.

4. The electronic program guide of claim 2, wherein the information of television programs comprises program names or playing order.

5. An electronic program guide, comprising:
a plurality of program category groups each comprising at least one television program.

6. The electronic program guide of claim 5, wherein the program category groups comprise a movie category, a sports category, a NEWS category, a music category, or combinations thereof.

7. The electronic program guide of claim 5, wherein each program category group further comprises information of a television channel playing the television program.

8. The electronic program guide of claim 7, wherein the information of the television channel comprises a channel name or an associated channel number.

9. A method for forming an electronic program guide, comprising:
generating a plurality of program category groups; and
categorizing a plurality of television channels into the program category groups according to program categories of the television channels.

10. The method of claim 9, wherein the program category groups comprise a movie category, a sports category, a NEWS category, a music category, or combinations thereof.

11. The method of claim 9, further comprising adding information of television programs played in the television channel into each program category group.

12. The method of claim 11, wherein the information of television programs comprises program names or playing order.

13. A method for forming an electronic program guide, comprising:
generating a plurality of program category groups; and
categorizing a plurality of television programs into the program category groups according to program categories of the television programs.

14. The method of claim 13, wherein the program category groups comprise a movie category, a sports category, a NEWS category, a music category, or combinations thereof.

15. The method of claim 13, further comprising adding information of a television channel playing the television programs into each program category group.

16. The method of claim 15, wherein the information of the television channel comprises a channel name or an associated channel number.
